(19) United States
(12) Patent Application Publication
(10) Pub. No.: US 2018/0186305 A1
(43) Pub. Date: Jul. 5, 2018

(54) SERVICE HOLE FASTENING CLIP ASSEMBLY

(71) Applicant: Illinois Tool Works Inc., Glenview, IL (US)

(72) Inventors: Hideki Kanie, Aichi (JP); Jason M. Zander, Hudson, WI (US)

(73) Assignee: Illinois Tool Works Inc., Glenview, IL (US)

(21) Appl. No.: 15/736,169

(22) PCT Filed: May 27, 2016
(86) PCT No.: PCT/US2016/034622

§ 371 Date: Dec. 13, 2017

Related U.S. Application Data
(60) Provisional application No. 62/190,340, filed on Jul. 9, 2015.

(51) Int. Cl. B60R 13/02; F16B 21/02; F16B 21/07; F16B 5/06

(52) U.S. Cl. CPC B60R 13/0206; F16B 21/02; F16B 19/1081; F16B 5/065; F16B 21/075

(57) ABSTRACT

A fastening system for a vehicle includes a service door having a first hole, a door panel having a second hole, and a fastening clip assembly that securely couples the service door to the door panel. The fastening clip assembly includes a post having a first portion that extends through the first hole and a second portion that extends through the second hole, a collar outwardly extending from the post, and a resilient sealing ring coupled to and extending outwardly from the collar. The resilient sealing ring is compressively and sealingly secured between the service door and the door panel.

### RELATED APPLICATIONS

This application relates to and claims priority benefits from U.S. Provisional Patent Application No. 62/190,340 entitled “Door Service Hole Fastening Clip Assembly,” filed Jul. 9, 2015, which is hereby incorporated by reference in its entirety.

### FIELD OF EMBODIMENTS OF THE DISCLOSURE

Embodiments of the present disclosure generally relate to a fastening clip assembly, and more particularly, to a fastening clip assembly configured to be secured to a service hole of a body panel of a vehicle, for example.

### BACKGROUND

Various assemblies include panels, components, or other such objects connected to one another. Automobile assemblies, for example, include various panels and structures connected to other panels or structures, or to the automobile frame itself.

Vehicle service doors are often secured to another component, such as a panel, frame, or the like. A securing clip may be secured within a hole of the service door and may connect to another component. Often, however, the securing clip is misaligned with the hole within the service door. As such, the connection between the service door and the component may be unstable or otherwise not fully secure.

### SUMMARY OF EMBODIMENTS OF THE DISCLOSURE

A need exists for a reliable securing clip, such as may be used with respect to a vehicle service door. With that need in mind, certain embodiments of the present disclosure provide a fastening clip assembly that is configured to securely couple a first component to a second component. The fastening clip assembly includes a post, a collar outwardly extending from the post, and a resilient sealing ring coupled to and extending outwardly from the collar. The resilient sealing ring is configured to be compressively and sealingly secured between the first component and the second component.

The sealing ring may include a resilient outer sealing flange that radially extends outwardly from the collar. The sealing flange is configured to pivotally deflect to sealingly close a gap between the first component and the second component in response to the fastening clip assembly securely coupling to the first component and the second component.

In at least one embodiment, the sealing flange includes a first sealing rim coupled to a second sealing rim. The first sealing rim is configured to extend toward the first component, and the second sealing rim is configured to extend toward the second component. An outer annular divot may be formed between the first sealing rim and the second sealing rim.

A gap may exist between the sealing ring and the first component when the fastening clip assembly is coupled to the first component but before the fastening clip assembly is coupled to the second component. The gap may be eliminated when the fastening clip assembly is coupled to the second component.

In at least one embodiment, the post includes a central passage formed therethrough. The central passage is configured to receive and retain a pin of a third component in order to securely couple the fastening clip assembly to the third component.

At least one securing beam may extend from the post. The securing beam(s) is configured to be passed through a reciprocal channel formed through the first component and rotated into a secure position between at least two locking protuberances extending from the first component.

At least one ramped clip may extend from the post. The ramped clip(s) is configured to securely couple the post to the second component. The post may include a beveled lead-in edge that is configured to guide the post into a hole of the second component.

Certain embodiments of the present disclosure provide a fastening system for a vehicle. The fastening system may include a service door having a first hole, a door panel having a second hole, and a fastening clip assembly that securely couples the service door to the door panel. The fastening clip assembly includes a post having a first portion that extends through the first hole and a second portion that extends through the second hole, a collar outwardly extending from the post, and a resilient sealing ring coupled to and extending outwardly from the collar. The resilient sealing ring is compressively and sealingly secured between the service door and the door panel.

The fastening system may also include a door trim having a pin. The post may include a central passage formed therethrough. The central passage retains a pin of the door trim to securely couple the fastening clip assembly to the door trim.

### BRIEF DESCRIPTION OF SEVERAL VIEWS OF THE DRAWINGS

FIG. 1 illustrates a perspective top view of a fastening clip assembly, according to an embodiment of the present disclosure.

FIG. 2 illustrates a perspective top view of a fastening clip assembly aligned with a hole formed through a service door, according to an embodiment of the present disclosure.

FIG. 3 illustrates a perspective view of a fastening clip assembly aligned with a hole of a component, according to an embodiment of the present disclosure.

FIG. 4 illustrates a perspective view of a fastening clip assembly securing a component to a body panel, according to an embodiment of the present disclosure.

FIG. 5 illustrates a cross-sectional view of a portion of a fastening clip assembly securing a component to a body panel through line 5-5 of FIG. 4, according to an embodiment of the present disclosure.

FIG. 6 illustrates an axial cross-sectional view of a fastening clip assembly secured to a component and axially aligned over a hole of a body panel, according to an embodiment of the present disclosure.

FIG. 7 illustrates an axial cross-sectional view of a fastening clip assembly securing a component to a body panel, according to an embodiment of the present disclosure.

FIG. 8 illustrates a perspective view of a fastening clip assembly aligned with a hole of a component, according to an embodiment of the present disclosure.

FIG. 9 illustrates a partial perspective cross-sectional view of a sealing ring of a fastening clip assembly separated from a component by a gap, according to an embodiment of the present disclosure.

FIG. 10 illustrates a perspective view of a fastening clip assembly secured to a component and aligned with a hole of a body panel, according to an embodiment of the present disclosure.

FIG. 11 illustrates a partial perspective cross-sectional view of a sealing ring of a fastening clip assembly compressively sandwiched between a component and a body panel, according to an embodiment of the present disclosure.

FIG. 12 illustrates a perspective view of a tool engaging a fastening clip assembly to remove the fastening clip assembly from the component, according to an embodiment of the present disclosure.

FIG. 13 illustrates a perspective view of a door trim aligned with a fastening clip assembly that secures a component to a body panel, according to an embodiment of the present disclosure.

FIG. 14 illustrates an axial cross-sectional view of a fastening clip assembly securing a door trim to a component and a body panel, according to an embodiment of the present disclosure.

Before the embodiments of the disclosure are explained in detail, it is to be understood that the disclosure is not limited in its application to the details of construction and the arrangement of the components set forth in the following description or illustrated in the drawings. The disclosure is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF EMBODIMENTS OF THE DISCLOSURE

Embodiments of the present disclosure provide fastening clip assemblies that are configured to be securely retained within a hole of a service door of a vehicle, for example.

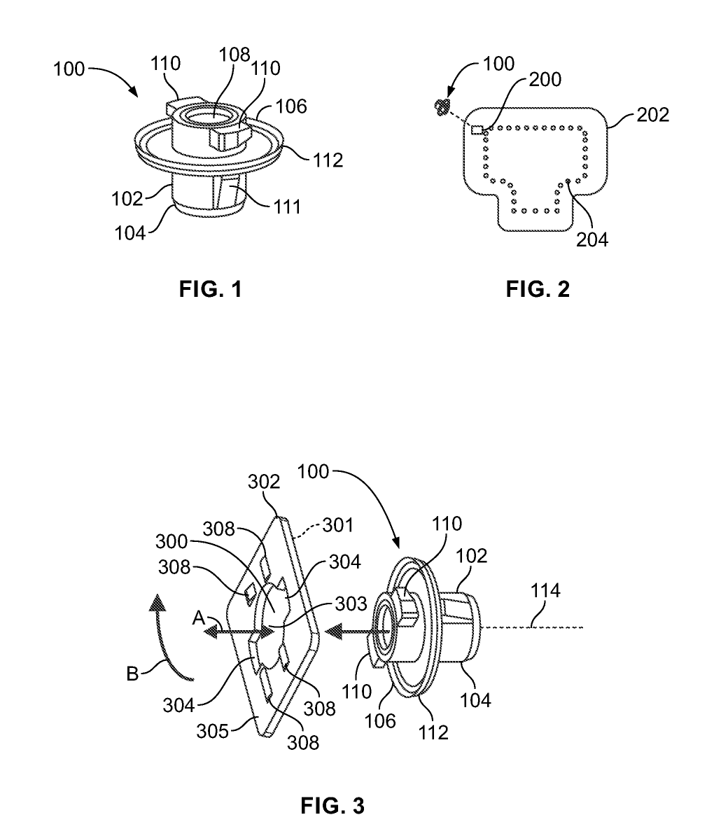

FIG. 1 illustrates a perspective top view of a fastening clip assembly 100, according to an embodiment of the present disclosure. The fastening clip assembly 100 includes a main body 102 having a tubular post 104 and an annular collar 106 radially and outwardly extending from the post 104. The post 104 may have a generally cylindrical shape. Optionally, the post 104 may be shaped differently, such as a rectangular beam. The main body 102 may be formed of a hard plastic. A central passage 108 may be formed through the post 104. In at least one other embodiment, the main body 102 does not include the central passage 108 (such that the main body 102 is not configured to accept a pin).

Securing beams 110 may outwardly extend from a top portion of the post 104. The securing beams 110 may be blocks, barbs, clasps, or other such protuberances extending radially outward from an outer surface of the post 104. As shown, two securing beams 110 extend radially outward from an outer surface of the post 104. Centers of the securing beams 110 may be radially spaced 180 degrees from one another. Alternatively, the main body 102 may include more or less securing beams 110 than shown. For example, a single securing beam 110 may extend from the post. In at least one other embodiment, three or more securing beams may be regularly spaced about the post 104.

Ramped clips 111 may extend from an outer surface of the post 104 below the collar 106. Two clips 111 may extend from the outer surface of the post 104 below the collar 106. Centers of the two clips 111 may be radially spaced 180 degrees from one another. The clips 111 are configured to snapably secure the main body 102 into a hole of a component. Alternatively, the main body 102 may include more or less ramped clips 111. As shown, the securing beams 110 and the ramped clips 111 may be on opposite sides of the collar 106.

A resilient sealing ring 112 may be coupled to an outer perimeter or portion of the collar 106. The sealing ring 112 may be formed of a soft plastic, such as thermoplastic elastomer. The sealing ring 112 may be secured to the outer perimeter of the collar 106, such as by compressively sandwiching the outer edge of the collar within an interior channel formed in the sealing ring 112, through one or more adhesives, and/or the like.

FIG. 2 illustrates a perspective view of the fastening clip assembly 100 aligned with a hole 200 formed through a service door 202, according to an embodiment of the present disclosure. The service door 202 may be that of a vehicle, for example. Sealing tape 204 may be secured to the service door 202. The fastening clip assembly 100 is axially aligned with the hole 200 and is configured to be urged into the hole 200.

FIG. 3 illustrates a perspective view of the fastening clip assembly 100 aligned with a hole 300 of a component 302, according to an embodiment of the present disclosure. The component 302 may be a portion of a service door of a vehicle, for example. The axial cross-section of the hole 300 may conform to an axial cross-section of an end of the fastening clip assembly 100. In order to secure the fastening clip assembly 100 to the component 302, the securing beams 110 are first aligned with reciprocal channels 304 (or other such open areas of the component 302 that allow passage of the securing beams 110) of the hole 300. For example, a longitudinal axis 114 may be axially aligned with a center 303 of the hole 300, and the securing beams 110 may be aligned with the reciprocal channels 304 in order to pass therethrough.

The fastening clip assembly 100 is then urged into the hole 300 in the direction of arrow A so that the securing beams 110 pass through the component 302 from a front or first side 301 to a rear or second side 305 by passing through the reciprocal channels 304. After the securing beams 110 have passed through the reciprocal channels 304, the fastening clip assembly 100 is rotated 90 degrees (for example, a quarter turn) in the direction of arrow B about the center 303 of the hole 300 in relation to the component 302 so that the securing beams 110 are rotated out of alignment with the reciprocal channels 304. During such rotation, each of the securing beams 110 is engaged between locking protuberances 308 (such as ribs, fins, ramps, ledges, ridges, or the like) that outwardly extend from the second side 305 of the component 302. In at least one embodiment, the securing beams 110 may be securely coupled (such as through a snap fit) between locking protuberances 308 formed on the component 302. As such, each securing beam 110 is trapped between opposed locking protuberances 308 on opposite sides of the hole 300.

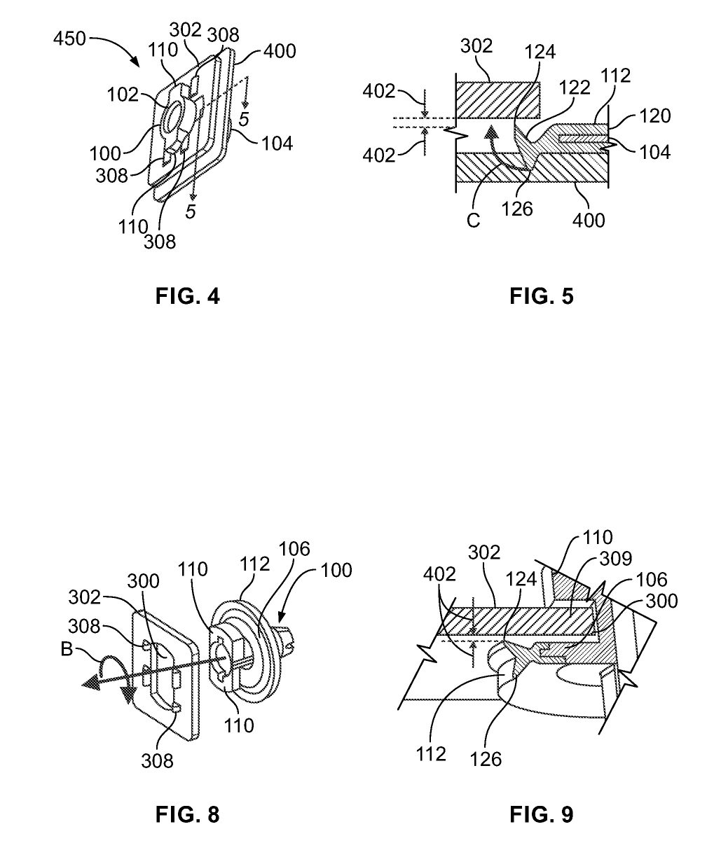

FIG. 4 illustrates a perspective view of the fastening clip assembly 100 securing the component 302 to a body panel 400, according to an embodiment of the present disclosure. As shown, a fastening system 450 includes the fastening clip assembly 100 securely coupling a first component (such as the component 302) to a second component (such as the body panel 400).

The fastening clip assembly 100 has been rotated a quarter turn such that the securing beams 110 are misaligned with the reciprocal channels 304 (and are therefore unable to retreat therethrough). Each securing beam 110 is securely trapped between opposed locking protuberances 308. A lower portion of the post 104 below the collar 106 (hidden from view in FIG. 4) extends through a hole formed in the body panel 400. The clips 111 (shown in FIG. 1) securely couple the main body 102 of the fastening clip assembly 100 to the body panel 400.

FIG. 5 illustrates a cross-sectional view of a portion of the fastening clip assembly 100 securing the component 302 to the body panel 400 through line 5-5 of FIG. 4, according to an embodiment of the present disclosure. As shown in FIG. 5, at least a portion of the collar 106 is securely positioned within an interior channel 120 formed through the sealing ring 112. For example, the sealing ring 112 may secure over and around the collar 106. In at least one other embodiment, the collar 106 and the sealing ring 112 may be integrally formed and molded together, such as an integrally-molded piece of elastomeric material.

The sealing ring 112 includes a resilient outer sealing flange 122 that radially extends outwardly from the collar 106. The sealing flange 122 includes a first sealing rim 124 coupled to a second sealing rim 126. The first sealing rim 124 extends toward the component 302, while the second sealing rim 126 extends toward the body panel 400. The first and sealing rims 124 and 126 may extend from the sealing ring 112 in opposite axial and/or radial directions.

Referring to FIGS. 4 and 5, in response to the fastening clip assembly 100 securing to the component 302 and the body panel 400 as shown in FIG. 4, the sealing flange 122 pivotally deflects in the direction of arc C to sealingly close a gap 402 between the component 302 and the sealing ring 112 and/or the body panel 400. The component 302 and the body panel 402 compressively sandwich the resilient outer flange 122 therebetween, thereby deflecting the outer flange 122 into the sealing position (for example, an installed position).

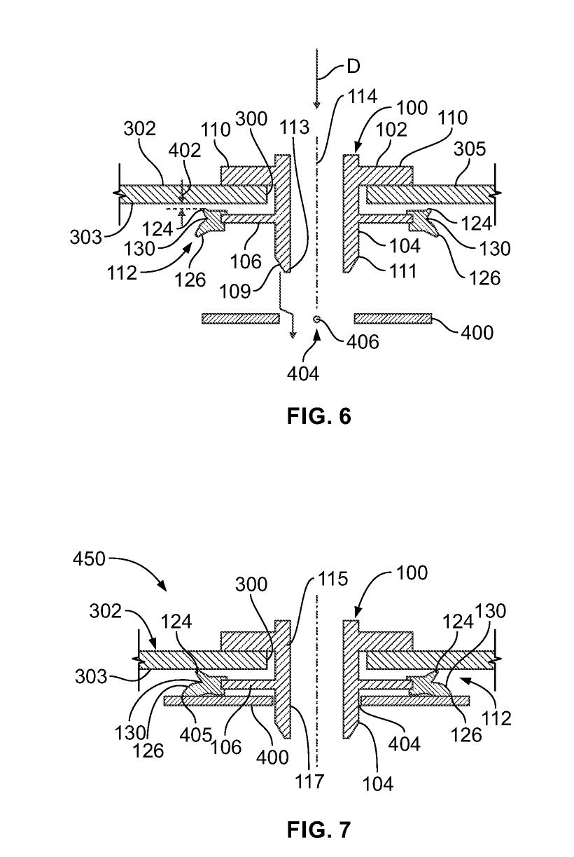

FIG. 6 illustrates an axial cross-sectional view of the fastening clip assembly 100 secured to the component 302 and axially aligned over a hole 404 of the body panel 400, according to an embodiment of the present disclosure. The securing beams 110 are secured to the component 302 on the second side 305.

The sealing ring 112 radially extends from the collar 106. As shown, the sealing ring 112 may be coupled to an outer edge of the collar 106. Optionally, the sealing ring 112 may extend over a greater or lesser portion of the collar 106 than shown.

The gap 402 may exist between the first surface 303 of the component 302 and the first sealing rim 124 of the sealing ring 112. The first sealing rim 124 and the second sealing rim 126 may be sized differently. For example, the first sealing rim 124 may not extend upwardly and/or radially from the collar 106 the same magnitude as the second sealing rim 126, in order to accommodate the size of the gap 402. Optionally, the first sealing rim 124 and the second sealing rim 126 may be mirror images of one another. In at least one other embodiment, the first sealing rim 124 may be larger than the second sealing rim 126.

An outer annular divot 130 may be formed between first and second sealing rims 124 and 126. The divot 130 allows the first and second sealing rims 124 and 126 to be compressed toward one another (while still exerting a sealing connection with the component 302 and the body panel 400) when the sealing ring 112 is compressed between the component 302 and the body panel 400.

In order to securely couple the component 302 to the body panel 400, the fastening clip assembly 100 is axially aligned with the hole 404 of the body panel 400 such that the central longitudinal axis 114 of the fastening clip assembly 100 is coaxially aligned with the center 406 of the hole 404. Once aligned, the fastening clip assembly 100 (having the component 302 secured thereto) is urged into the hole 404 in the direction of arrow D. The clips 111 (shown in FIG. 1) snapably secure the post 104 of the main body 102 to the body panel 400.

A distal end of the post 104 may include a beveled edge 109 (downwardly angling from an outer surface 111 towards an inner surface 113) that provides a lead-in nose that automatically guides the fastening clip assembly 100 into an axially aligned position with respect to the hole 404. Alternatively, the fastening clip assembly 100 may not include the beveled edge.

FIG. 7 illustrates an axial cross-sectional view of the fastening clip assembly 100 securing the component 302 to the body panel 400, according to an embodiment of the present disclosure. FIG. 7 shows a fastening system 450 in which the fastening clip assembly 100 securely couples a first component (such as the component 302) to a second component (such as the body panel 400). A first portion 115 (such a proximate a first end) of the post 104 extends through the hole 300 of the component 302, while a second portion 117 (such as proximate an opposite send end) of the post 104 extends through the hole 404 of the body panel 400. As the body panel 400 is secured to the post 104, the resilient sealing ring 112 is compressed between an upper surface 405 of the body panel 400 and the front (or lower) surface 303 of the component 302. The sealing ring 112 is deflected by the coupling of the component 302 to the body panel 400 through the fastening clip assembly 100. The first sealing rim 124 deflects into and sealingly abuts the surface 303 of the component 302, while the second sealing rim 124 deflects into and sealingly abuts the surface 405 of the body panel 400, thereby eliminating the gap 402 (shown in FIG. 6). As such, the sealing ring 112 provides an adaptive sealing member that provides a fluid-tight seal between the fastening clip assembly 100, the component 302, and the body panel 400. Additionally, the sealing ring 112 exerts a stabilizing force into both the component 302 and the body panel 400 that eliminates, minimizes, or otherwise reduces shifting, rattling, and/or the like therebetween.

FIG. 8 illustrates a perspective view of the fastening clip assembly 100 aligned with the hole 300 of the component 302, according to an embodiment of the present disclosure. The component 302 may be a body panel of a vehicle, such as a door service hole cover, for example. As shown, the hole 300 may be sized and shaped more as a rectangle, as compared to the embodiment shown in FIG. 3, for example. The hole 300 may be sized and shaped differently than shown.

FIG. 9 illustrates a partial perspective cross-sectional view of the sealing ring 112 of the fastening clip assembly 100 separated from the component 302 by the gap 402, according to an embodiment of the present disclosure. As shown, an interior edge 309 of the component 302 that defines the hole 300 is trapped between the securing beams 110 and the collar 106.

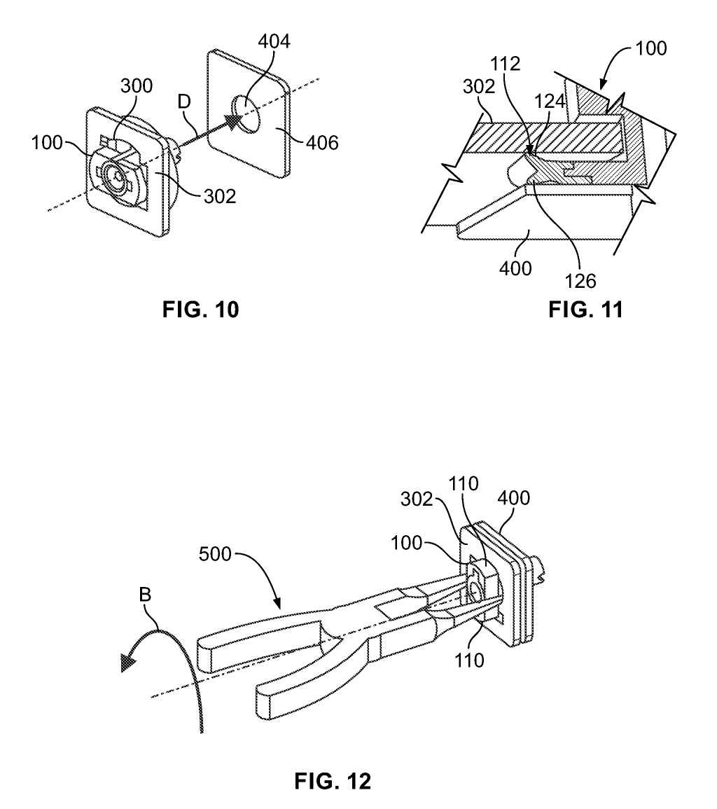

FIG. 10 illustrates a perspective view of the fastening clip assembly 100 secured to the component 302 and aligned with the hole 404 of the body panel 400, according to an embodiment of the present disclosure. The body panel 400 may be a door panel of a vehicle, for example. As described above, the fastening clip assembly 100 (having the component 302 secured thereto) is urged into the hole 404 in the direction of arrow D.

FIG. 11 illustrates a partial perspective cross-sectional view of the sealing ring 112 of the fastening clip assembly 100 compressively sandwiched between the component 302 and the body panel 400, according to an embodiment of the present disclosure. As the fastening clip assembly 100 secures to the body panel 400, the sealing ring 112 is deflected into a secure, sealing engagement between the component 302 and the body panel 400, such that the first sealing rim 124 sealingly abuts into the component 302, while the second sealing rim 126 abuts into the body panel 400.

In the installed position (in which the fastening clip assembly 100 securely couples the component 302 to the body panel 400), the sealing ring 112 is sandwiched between the component 302 and the body panel 400. As such, the sealing ring 112 provides a robust seal between the component 302, the body panel 400, and the fastening clip assembly 100, while also stabilizing the component 302 in relation to the body panel 400, which eliminates, minimizes, or otherwise reduces shifting, rattling, and/or the like between the component 302 and the body panel 400.

Referring to FIGS. 9 and 11, the gap 402 may exist before the fastening clip assembly 100 is coupled to the body panel 400. In response to the fastening clip assembly 100 securing to the body panel 400, the sealing ring 112 deflects into the component 302, and the gap 402 is eliminated.

In at least one embodiment, the fastening clip assembly 100 is pre-assembled with the component 302. The pre-assembly is configured to be secured to the body panel 400 as described.

FIG. 12 illustrates a perspective view of a tool 500 engaging the fastening clip assembly 100 to remove the fastening clip assembly 100 from the component 302, according to an embodiment of the present disclosure. The tool 500 may be pliers that are used to engage the portion of the fastening clip assembly 100 on one side of the collar 106 (shown in FIG. 8) and rotate the fastening clip assembly 100 in the direction of arc B so that the securing beams 110 align with the channels or portion of the hole 300 and may then pass therethrough.

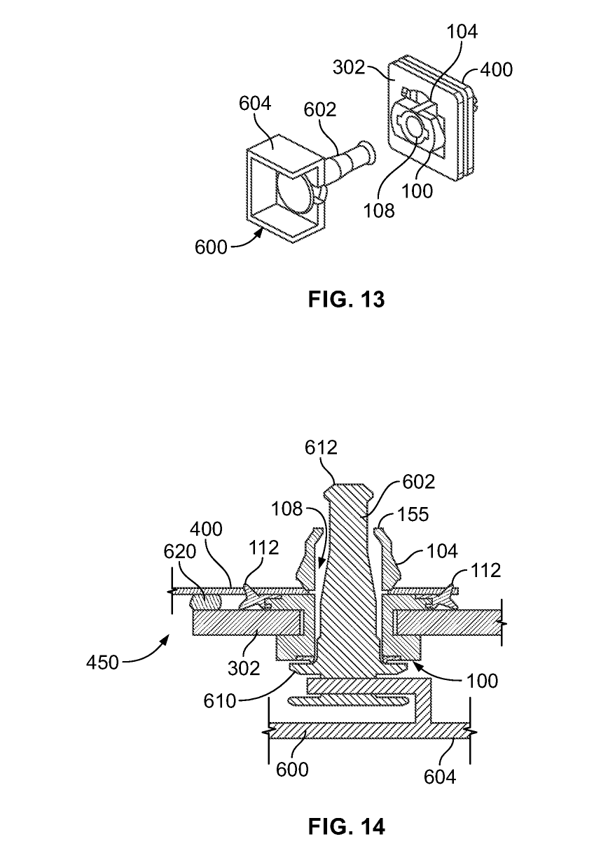

FIG. 13 illustrates a perspective view of a door trim 600 aligned with the fastening clip assembly 100 that secures the component 302 to the body panel 400, according to an embodiment of the present disclosure. The door trim 600 may include a pin 602 secured to a bracket 604. The pin 602 is configured to be secured into the central passage 108 formed through the post 104 of the fastening clip assembly 100. Alternatively, in at least one other embodiment, the fastening clip assembly 100 is not configured to receive and retain a pin. For example, the fastening clip assembly 100 may not include the central passage 108.

FIG. 14 illustrates an axial cross-sectional view of the fastening clip assembly 100 securing the door trim 600 to the component 302 and the body panel 400, according to an embodiment of the present disclosure. FIG. 14 shows a fastening system 450 for a vehicle that includes the fastening clip assembly 100 that securely couples a first component (such as the component 302, which may be a service door) to a second component (such as the body panel 400) and a third component (such as the door trim 600). As shown, the pin 602 includes a head 610 that has a larger diameter than that of the passage 108 (and is therefore unable to pass therein), while a distal end 612 may have a diameter that is greater than an opening through a distal end 155 defined by the post 104 in an at-rest position (such that the distal end of the post 104 is not urged open). An additional seal 620 may be disposed between the component 302 and the body panel 400.

As described above, embodiments of the present disclosure provide reliable fastening clip assemblies that provide a robust sealing engagement between two or more components. The fastening clip assemblies may be used with respect to vehicle service doors, for example.

It is to be understood that use of numeric indicators, such as “first,” “second,” “third,” and “fourth,” is merely to indicate a number of a particular component, structure, feature, and/or the like. For example, use of “first” and “second,” may be reversed, such that a first component is a second component.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present disclosure. It is understood that the embodiments disclosed and defined herein extend to all alternative combinations of two or more of the individual features mentioned or evident from the text and/or drawings. All of these different combinations constitute various alternative aspects of the present disclosure. The embodiments described herein explain the best modes known for practicing the disclosure and will enable others skilled in the art to utilize the disclosure. The claims are to be construed to include alternative embodiments to the extent permitted by the prior art.

To the extent used in the appended claims, the terms “including” and “in which” are used as the plain-English equivalents of the respective terms “comprising” and “wherein.” Moreover, to the extent used in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

Various features of the disclosure are set forth in the following claims.

1. A fastening clip assembly that is configured to securely couple a first component to a second component, the fastening clip assembly comprising:
a post;
a collar outwardly extending from the post; and
a resilient sealing ring coupled to and extending outwardly from the collar, wherein the resilient sealing ring is configured to be compressively and sealingly secured between the first component and the second component.

2. The fastening clip assembly of claim 1, wherein the sealing ring comprises a resilient outer sealing flange that radially extends outwardly from the collar.

3. The fastening clip assembly of claim 2, wherein the sealing flange is configured to pivotally deflect to sealingly close a gap between the first component and the second component in response to the fastening clip assembly securely coupling to the first component and the second component.

4. The fastening clip assembly of claim 2, wherein the sealing flange comprises a first sealing rim coupled to a second sealing rim, wherein the first sealing rim is configured to extend toward the first component, and wherein the second sealing rim is configured to extend toward the second component.

5. The fastening clip assembly of claim 4, wherein an outer annular divot is formed between the first sealing rim and the second sealing rim.

6. The fastening clip assembly of claim 1, wherein a gap exists between the sealing ring and the first component when the fastening clip assembly is coupled to the first component but before the fastening clip assembly is coupled to the second component, and wherein the gap is eliminated when the fastening clip assembly is coupled to the second component.

7. The fastening clip assembly of claim 1, wherein the post comprises a central passage formed therethrough, wherein the central passage is configured to receive and retain a pin of a third component in order to securely couple the fastening clip assembly to the third component.

8. The fastening clip assembly of claim 1, further comprising at least one securing beam extending from the post, wherein the at least one securing beam is configured to be passed through a reciprocal channel formed through the first component and rotated into a secure position between at least two locking protuberances extending from the first component.

9. The fastening clip assembly of claim 1, further comprising at least one ramped clip extending from the post, wherein the at least one ramped clip is configured to securely couple the post to the second component.

10. The fastening clip assembly of claim 1, wherein the post comprises a beveled lead-in edge that is configured to guide the post into a hole of the second component.

11. A fastening system for a vehicle, the fastening system comprising:
a service door having a first hole;
a door panel having a second hole; and
a fastening clip assembly that securely couples the service door to the door panel, the fastening clip assembly comprising:
a post having a first portion that extends through the first hole and a second portion that extends through the second hole;
a collar outwardly extending from the post; and
a resilient sealing ring coupled to and extending outwardly from the collar, wherein the resilient sealing ring is compressively and sealingly secured between the service door and the door panel.

12. The fastening system of claim 11, wherein the sealing ring comprises a resilient outer sealing flange that radially extends outwardly from the collar.

13. The fastening system of claim 12, wherein the sealing flange pivotally deflects to sealingly close a gap between the service door and the door panel in response to the fastening clip assembly securely coupling to the service door and the door panel.

14. The fastening system claim 12, wherein the sealing flange comprises a first sealing rim coupled to a second sealing rim, wherein the first sealing rim extends toward the service door, and wherein the second sealing rim extends toward the door panel.

15. The fastening system of claim 14, wherein an outer annular divot is formed between the first sealing rim and the second sealing rim.

16. The fastening system of claim 11, wherein a gap exists between the sealing ring and the service door when the fastening clip assembly is coupled to the service door but before the fastening clip assembly is coupled to the door panel, and wherein the gap is eliminated when the fastening clip assembly is coupled to the door panel.

17. The fastening system of claim 11, further comprising a door trim having a pin, wherein the post comprises a central passage formed therethrough, and wherein the central passage retains a pin of the door trim to securely couple the fastening clip assembly to the door trim.

18. The fastening system of claim 11, further comprising at least one securing beam extending from the post, wherein the at least one securing beam passes through a reciprocal channel formed through the service door and is rotated into a secure position between at least two locking protuberances extending from the service door.

19. The fastening system of claim 11, wherein the post comprises a beveled lead-in edge that is configured to guide the post into the second hole.

20. A fastening system for a vehicle, the fastening system comprising:
a service door comprising at least two locking protuberances and a first hole;
a door panel having a second hole;
a door trim having a pin; and
a fastening clip assembly that securely couples the service door to the door panel, the fastening clip assembly comprising:
a post comprising a central passage formed therethrough, a first portion that extends through the first hole, a second portion that extends through the second hole, and a beveled lead-in edge that is configured to guide the post into the second hole, wherein the central passage retains the pin of the door trim to securely couple the fastening clip assembly to the door trim;
at least one securing beam extending from the post, wherein the at least one securing beam passes through a reciprocal channel formed through the service door and is rotated into a secure position between the at least two locking protuberances;
a collar outwardly extending from the post; and
a resilient sealing ring coupled to and extending outwardly from the collar, wherein the sealing ring comprises a resilient outer sealing flange that radially extends outwardly from the collar, wherein the resilient sealing ring is compressively and sealingly secured between the service door and the door panel, wherein the sealing flange comprises a first sealing rim coupled to a second sealing rim, wherein an outer annular divot is formed between the first sealing rim and the second sealing rim, wherein the first sealing rim extends toward the service door, wherein the second sealing rim extends toward the door panel, and wherein the sealing flange pivotally deflects to sealingly close a gap between the service door and the door panel in response to the fastening clip assembly securely coupling to the service door and the door panel.
